(19) United States
(12) Patent Application Publication
(10) Pub. No.: US 2015/0059218 A1
(43) Pub. Date: Mar. 5, 2015

(54) Scrapbook cards

(71) Applicant: Colleen Daniels, Wilkes Barre, PA (US)

(72) Inventor: Colleen Daniels, Wilkes Barre, PA (US)

(21) Appl. No.: 14/476,096

(22) Filed: Sep. 3, 2014

Related U.S. Application Data
(60) Provisional application No. 61/873,453, filed on Sep. 4, 2013.

(51) Int. Cl. B42D 15/02; B32B 38/08; B32B 37/12

(52) U.S. Cl. CPC B42D 15/02; B32B 37/12; B32B 38/08
USPC 40/124.01; 156/60; 156/277; 156/280

(57) ABSTRACT

A series of decorative adhesive greeting cards to commemorate special occasions in scrapbooks is provided. The greeting cards are printed in full color and may feature a peel-and-stick removable adhesive backing, and may be customized with print writing, handwriting, photographs, a memorable document, and other common scrapbooking articles. The cards are specially created and designed with removable embellishments, using such processes as perforations and die cutting. The various embellishments may provide a three dimensional texture or raised element, or may comprise flat printed words and images. A set of prepared decorations, such as paper frames, removable titles, numbers, clip art, and the like may be mixed and matched to create an infinite variety of scrapbook items that may be placed within a scrapbook.

### CROSS-REFERENCE TO RELATED APPLICATIONS

This application claims the benefit of U.S. Provisional Application No. 61/873453, filed Sep. 4, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to hobby and craft supplies and accessories and in particular to decorative greeting cards for commemorating special occasions in scrapbooks. The hobby of scrapbooking has become very popular, as users create elaborate scrapbooks which combine photos, written messages, bits of wrapping paper and ribbons, and assorted other items to create unique written histories of their families. In an age that has become increasingly electronic and impersonal, scrapbooks become a delightful anachronism for many users. These people often choose decorative accents for their scrapbooks that provide reminders of weddings, graduations, class reunions, holiday gatherings, and other very special days in their families' lives. Greeting cards are often purchased for such occasions, but these are often discarded. A series of decorative adhesive greeting cards to commemorate these special occasions, and then become part of a scrapbook collection after being used as greeting cards, would appeal to many scrapbook users.

### SUMMARY OF THE INVENTION

Accordingly, the invention is directed to decorative greeting cards for commemorating special occasions in scrapbooks. A series of decorative removable adhesive greeting cards to commemorate special occasions would appeal to many scrapbook users. The greeting cards are printed in full color and may feature a peel-and-stick removable adhesive backing, and may be customized with print writing, handwriting, photographs, a memorable document, and other common scrapbooking articles. The cards are specially created and designed with removable embellishments, using such processes as perforations and die cutting. The various embellishments may provide a three dimensional texture or raised element, or may comprise flat printed words and images. A set of prepared decorations, such as paper frames, removable titles, numbers, clip art, and the like may be mixed and matched to create an infinite variety of scrapbook items that may be placed within a scrapbook.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

FIG. 1 shows a front view of the separated components of the first exemplary embodiment, displaying the printed message 10, the decorative border 11, the decorative background 12, the small clip art items 13, and the large clip art item 14.

FIG. 2 shows a front view of several components of the first exemplary embodiment assembled for a scrapbook, displaying the printed message 10, the decorative border 11, the decorative background 12, and the large clip art item 14.

FIG. 3 shows a front view of the first exemplary embodiment, displaying the printed message 10, the decorative border 11, the decorative background 12, the small clip art items 13, and the large clip art item 14.

FIG. 4 shows a front view of several components of the first exemplary embodiment as repositioned for a scrapbook, with the large decorative item removed and the printed message repositioned, displaying the printed message 10, the decorative border 11, the decorative background 12, and the small clip art items 13.

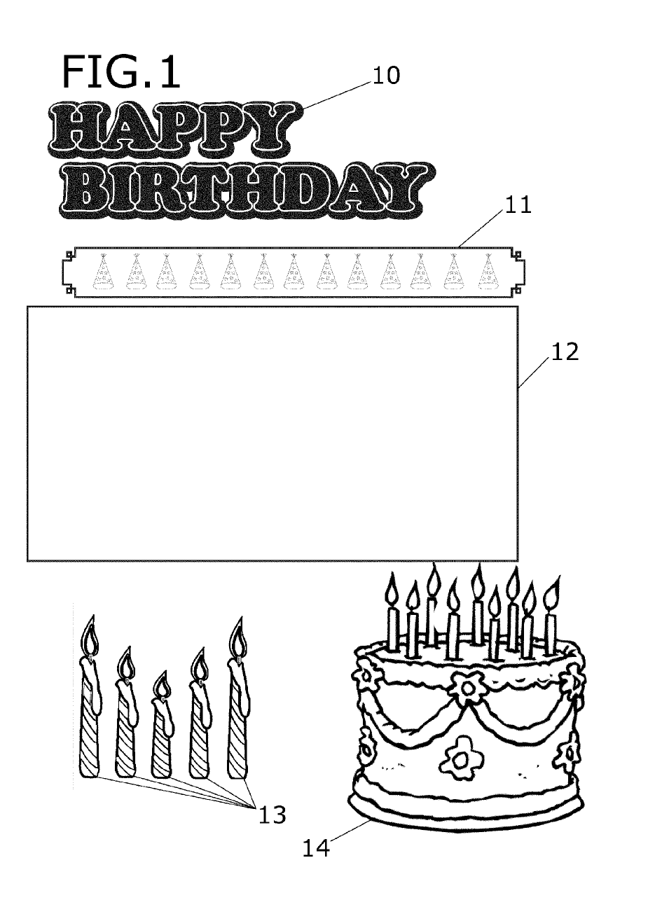

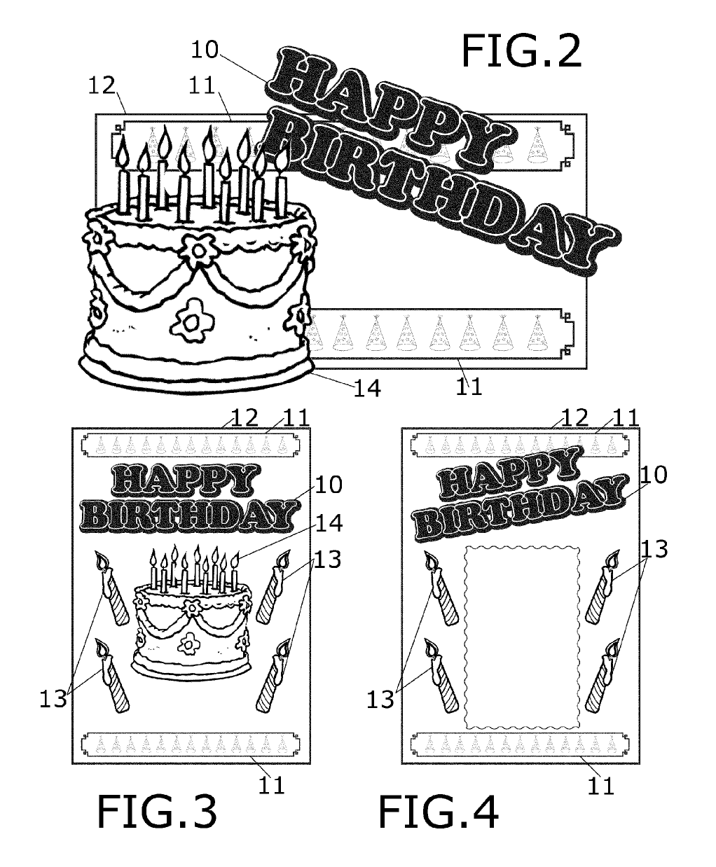

### DETAILED DESCRIPTION OF THE INVENTION

Referring now to the invention in more detail, the invention is directed to a system of decorative greeting cards for commemorating special occasions in scrapbooks. A series of decorative removable adhesive greeting cards to commemorate special occasions would appeal to many scrapbook users. The greeting cards are printed in full color and may feature a peel-and-stick removable adhesive backing, and may be customized with print writing, handwriting, photographs, a memorable document, and other common scrapbooking articles. The cards are specially created and designed with removable embellishments, using such processes as perforations and die cutting. The various embellishments may provide a three dimensional texture or raised element, or may comprise flat printed words and images. A set of prepared decorations, such as paper frames, removable titles, numbers, clip art, and the like may be mixed and matched to create an infinite variety of scrapbook items that may be placed within a scrapbook.

The first exemplary embodiment is printed as a birthday card, featuring as its components a printed message 10, a decorative border 11, a decorative background 12, four small clip art items 13, and one large clip art item 14. A broad variety of alternate embodiments, printed as birthday cards or as greeting cards for other occasions, and featuring a broad assortment of different components, is also contemplated. To use the first exemplary embodiment, the user removes the paper backing from the peel-and-stick adhesive on the rear surface of each component, and affixes each component in the desired position for a greeting card. After the special occasion, the user carefully peels off one or more components as desired, and removes or repositions them in the desired positions for a scrapbook display.

The printed messages 10, the decorative borders 11, the decorative backgrounds 12, the small clip art items 13, and the large clip art items 14 are preferably manufactured from a flexible, durable material such as paper or cardstock. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system of decorative greeting cards for use in scrapbooks comprising a printed message, a decorative background, a decorative border, and a plurality of clip art items; said printed message, said decorative background, said decorative border, said plurality of clip art items all being applied with peel-and-stick backing.

2. A method of using the system of decorative greeting cards for use in scrapbooks of claim 1 comprising arranging and affixing any of the group of said printed message, said decorative background, said decorative border, or any of said plurality of clip art items on one or more scrapbook pages; and arranging and applying any of the group of handwriting, print writing, photographs, or memorable documents to said scrapbook page in conjunction therewith.

3. The system of decorative greeting cards for use in scrapbooks of claim 1 wherein said plurality of clip art items comprises a plurality of large clip art items and a plurality of small clip art items.

4. A method of using the system of decorative greeting cards for use in scrapbooks of claim 3 comprising arranging and affixing any of the group of said printed message, said decorative background, said decorative border, or any of said plurality of clip art items on one or more scrapbook pages; and arranging and applying any of the group of handwriting, print writing, photographs, or memorable documents to said scrapbook page in conjunction therewith.

5. The system of decorative greeting cards for use in scrapbooks of claim 1 wherein said printed message, said decorative background, said decorative border, and said plurality of clip art items are themed to an occasion.

6. The system of decorative greeting cards for use in scrapbooks of claim 5 wherein said themed occasion is a birthday.

7. The system of decorative greeting cards for use in scrapbooks of claim 5 wherein said plurality of clip art items comprises a plurality of large clip art items and a plurality of small clip art items.

8. A method of using the system of decorative greeting cards for use in scrapbooks of claim 5 comprising arranging and affixing any of the group of said printed message, said decorative background, said decorative border, or any of said plurality of clip art items on one or more scrapbook pages; and arranging and applying any of the group of handwriting, print writing, photographs, or memorable documents to said scrapbook page in conjunction therewith.

9. The system of decorative greeting cards for use in scrapbooks of claim 8 wherein said plurality of clip art items comprises a plurality of large clip art items and a plurality of small clip art items.

10. The system of decorative greeting cards for use in scrapbooks of claim 6 wherein said plurality of clip art items comprises a plurality of large clip art items and a plurality of small clip art items.

11. A method of using the system of decorative greeting cards for use in scrapbooks of claim 6 comprising arranging and affixing any of the group of said printed message, said decorative background, said decorative border, or any of said plurality of clip art items on one or more scrapbook pages; and arranging and applying any of the group of handwriting, print writing, photographs, or memorable documents to said scrapbook page in conjunction therewith.

12. The system of decorative greeting cards for use in scrapbooks of claim 11 wherein said plurality of clip art items comprises a plurality of large clip art items and a plurality of small clip art items.
